(19) United States
(12) Patent Application Publication
(10) Pub. No.: US 2008/0001485 A1
(43) Pub. Date: Jan. 3, 2008

(54) System and method for curing and consolidation of coil with insulation

(76) Inventors: Ram Kumar Upadhyay, Niskayuna, NY (US); Garth M. Nelson, Ballston Lake, NY (US); Patricia Chapman Irwin, Altamont, NY (US); Bowden Kirkpatrick, Bennington, VT (US); Donald Lee Cousins, Erie, PA (US)

Correspondence Address: GENERAL ELECTRIC COMPANY (PCPI);C/O FLETCHER YODER, P. O. BOX 692289, HOUSTON, TX, 77269-2289, US

(21) Appl. No.: 11/479,162

(22) Filed: Jun. 30, 2006

(51) Int. Cl. H02K 15/00

(52) U.S. Cl. 310/42; 264/510; 425/389

(57) ABSTRACT

A system for curing and consolidation of coil with insulation includes an insulation layer disposed around an electrical coil. A release layer disposed around the insulation layer. A breather layer is disposed around the release layer. A vacuum bag structure is disposed around the breather layer without using a molding structure.

### BACKGROUND

The invention relates generally to coils and, more particularly, a method for insulating a coil.

Many different types of electrical machines employ windings and other conductors surrounded by insulation. For example, motors and generators may include rotors and stators having insulated windings or coils. The integrity of the insulation can affect performance, useful life, and other characteristics of the electrical machines. Unfortunately, existing techniques for insulating electrical machines, e.g., coils, require the use of mold tooling and may result in consolidation defects.

Insulating systems may break down for many reasons, however, jeopardizing the good operating state of the machines and circuits. The winding insulation, for example, for electric machines is subject to damage and deterioration, caused by electrical, mechanical, chemical, and environmental stresses. Typical insulation failure occurs in slots between turns and at end windings. When the winding insulation fails or degrades, machine failure can result, as well as loss of useful life of the machine and increased costs due to repair and machine outage. The integrity of the insulation systems is important to the proper function and useful life of the machines and circuits in which they are installed. The conventional techniques fail to achieve uniform consolidation of insulation system, especially around complex geometries, for example, terminal ends of electrical coils of the traction motor. The non-uniform consolidation results in pathways for water seepage and reduction in insulation capacity of the coil during wet conditions.

### BRIEF DESCRIPTION

In accordance with one aspect of the present technique, a method includes disposing a vacuum bag structure surrounding an insulation layer along a surface of an electrical coil. The method also includes consolidating the insulating layer about the electrical coil via the vacuum bag structure without using a mold structure.

In accordance with another aspect of the present technique, a system includes an insulation layer disposed around a coil. A release layer is disposed around the insulation layer. A breather layer is disposed around the release layer. A vacuum bag structure is disposed around the breather layer without using a molding structure.

In accordance with another aspect of the present technique, an electromechanical device includes an electrical coil and a vacuum-bag-consolidated layer disposed about the electrical coil.

In accordance with another aspect of the present technique, a system includes a vehicle traction mechanism, an electrical coil, and a vacuum-bag-consolidated layer disposed about the electrical coil.

In accordance with another aspect of the present technique, a method includes creating a vacuum in a bag surrounding an insulation layer along a surface of an electrical coil. The method also includes curing the insulation layer.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical view of an embodiment of a locomotive including a traction motor having a coil with reinforced insulation;

FIG. 2 is a diagrammatical view of an embodiment of the traction motor of FIG. 1;

FIG. 3 is a perspective view of an embodiment of a traction motor coil with an insulation layer for use with the traction motor of FIGS. 1 and 2;

FIG. 4 is a cross-sectional view of an embodiment of a traction motor coil with an insulation layer for use with the traction motor of FIGS. 1 and 2, wherein the insulation layer is consolidated within a breather layer and a vacuum bag structure;

FIG. 5 is a cross-sectional view of an embodiment of a traction motor coil with an insulation layer for use with the traction motor of FIGS. 1 and 2, wherein the insulation layer is consolidated within a breather layer and a vacuum bag structure having a plurality vacuum ports;

FIG. 6 is a diagrammatical view of an embodiment of an autoclave used to cure a traction motor coil with an insulation layer for use with the traction motor of FIGS. 1 and 2, wherein the insulation layer is consolidated and cured within a breather layer and a vacuum bag structure;

FIG. 7 is a perspective view of an embodiment of an oven used to cure a traction motor coil with an insulation layer for use with the traction motor of FIGS. 1 and 2, wherein the insulation layer is consolidated and cured within a breather layer and a vacuum bag structure;

FIG. 8 is a cross-sectional view of an embodiment of a traction motor coil with an insulation layer for use with the traction motor of FIGS. 1 and 2, wherein the insulation layer is consolidated within a breather layer and a single bag having a plurality vacuum ports;

FIG. 9 is a cross-sectional view of an embodiment of a traction motor coil with an insulation layer for use with the traction motor of FIGS. 1 and 2, wherein the insulation layer is consolidated within a breather layer and a single tubular bag having a plurality of vacuum ports;

FIGS. 10 and 11 are graphs illustrating embodiments of a variation of pressure and temperature relative to time during a curing cycle of a traction motor coil with an insulation layer consolidated within a vacuum bag system; and

FIGS. 12 and 13 are flow charts illustrating embodiments of processes for curing a traction motor coil with an insulation layer.

### DETAILED DESCRIPTION

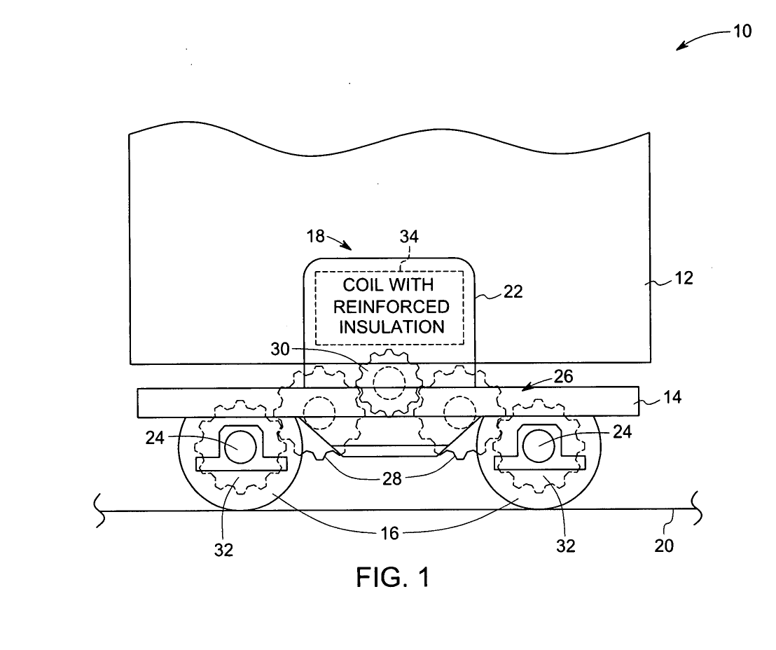

As discussed in detail below, embodiments of the present invention provide a method to cure and consolidate an insulation layer about an electrical coil via a vacuum bag structure without using a mold structure. The method includes creating a vacuum (i.e. partial vacuum) in a bag surrounding the insulation layer provided along a surface of an electrical coil and curing the insulation layer inside an autoclave to a predetermined temperature and pressure. The exemplary method uses the electrical coil itself as a tool, and therefore does not require a mold or additional tooling for curing and consolidation of the insulation layer to the surface of the electrical coil. In accordance with certain embodiments, uniform consolidation of the insulation layer to the entire surface of the electrical coil is achieved. The uniform consolidation of the insulation layer to the electrical coil substantially reduces or prevents seepage of water to the electrical coil during wet operation conditions of the electrical coil. Certain exemplary embodiments provide a vehicle including a traction mechanism having an electrical coil and a vacuum-bag-consolidated insulation layer disposed about the electrical coil. Certain other exemplary embodiments provide a system including an insulation layer, release layer, breather layer and a vacuum bag structure disposed around an electrical coil without using a mold structure. Specific embodiments are discussed in greater detail below referring generally to FIG. 1-13.

Referring to FIG. 1, an exemplary vehicle (for example, a locomotive) 10 is illustrated in accordance with certain embodiments. The vehicle 10 includes a locomotive body 12 supported on a bogie frame 14. The bogie frame 14 is supported by a plurality of wheels 16. The vehicle 10 includes a traction mechanism (electromechanical device) 18 configured to drive the wheels 16 along a railway track 20. The traction mechanism 18 includes a traction motor 22 provided to the bogie frame 14. The traction motor 22 may be a direct current (DC) motor or an alternate current (AC) motor. The traction motor 22 drives an axle 24 of each wheel 16 via a gear train 26. The gear train 26 includes a plurality of intermediate gear wheels 28 configured to engage a pinion gear 30 coupled to the traction motor 22 and a plurality of main gear wheels 32 coupled to the axles 24 of the wheels 16. When the motor 22 is driven, the rotation of the pinion gear 30 is transmitted to the axles 24 of the wheels 16 via the intermediate gear wheels 28 and the main gearwheels 32. In certain embodiments, the motor 22 may be used as a generator during dynamic braking of the vehicle. Although a locomotive is illustrated, it is to be noted that certain embodiments may be applicable to other applications where insulation is disposed about electrical coils.

Motors and generators may include wound rotors and stators, or may include preformed windings or coils. The conductors may serve either to conduct electrical current, or to produce magnetic fields by virtue of the flow of such current. Insulation systems separate conductors and windings from one another, and from adjacent components in the assembled system. Such insulation systems may include various varnish systems, tapes, coatings, sleeves, and so forth, or combinations of these. The disclosed traction motor 22 includes an electrical coil 34 with a reinforced insulation layer that is uniformly consolidated to the electrical coil 34, especially around complex geometries of the coil 34. The disclosed vacuum bag curing and consolidation techniques generally provide uniform consolidation, thereby improving resistance to water seepage, deterioration, and machine failures. The exemplary electrical coil 34 with the insulation layer and the technique used for consolidating insulation systems are discussed in greater detail with reference to subsequent figures.

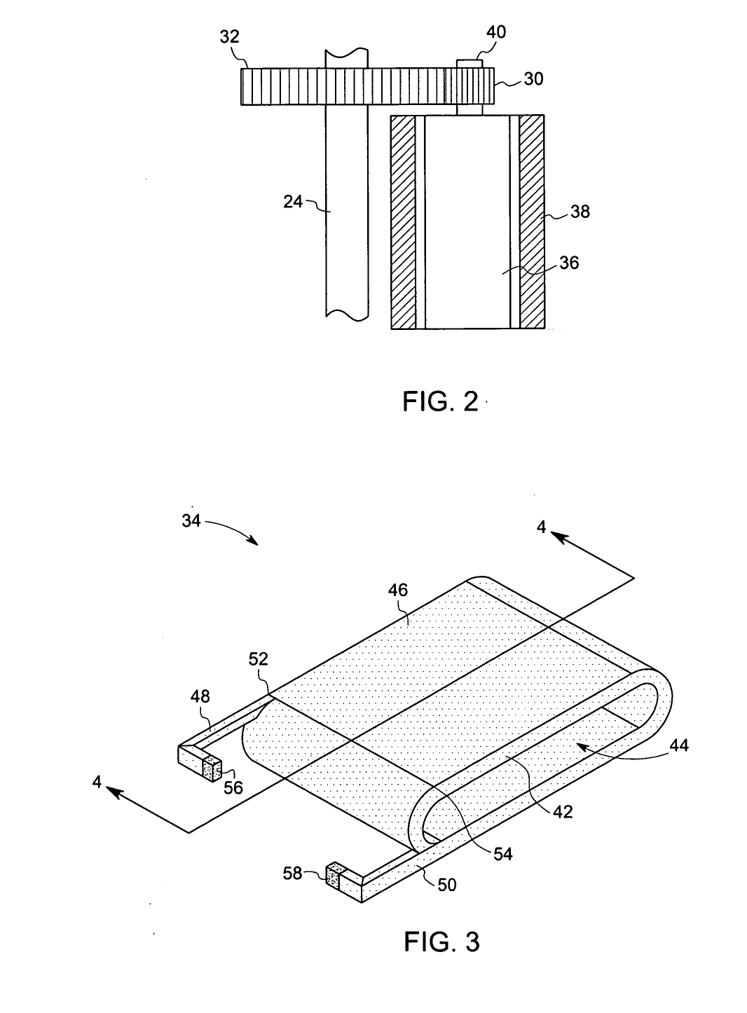

Referring now to FIG. 2, the traction motor 22 in accordance with embodiments of FIG. 1 is illustrated. The traction motor 22 includes a rotor 36 disposed inside a stator 38. The rotor 36 is coupled to the pinion gear 30 via an armature drive shaft 40. The pinion gear 30 is configured to engage the main gearwheel 32 coupled to the axle 24 of the wheel. Rotary motion of the traction motor 22 is generated by the interaction of magnetic field caused by current flowing through the stator 38 and the rotor 36. In certain embodiments, the rotor 36 and the stator 38 are electrically coupled via a plurality of spring loaded fixed carbon brushes. In accordance with certain embodiments, the stator 38 includes one or more electrical coils 34 (illustrated in FIG. 1) having a reinforced insulation layer that is uniformly consolidated to the electrical coil 34, especially around complex geometries of the coil 34. The disclosed vacuum bag curing and consolidation techniques generally provide uniform consolidation, thereby improving resistance to water seepage, deterioration, and machine failures. The coil 34 is discussed in greater detail below.

Referring to FIG. 3, the exemplary electrical coil 34 is illustrated in accordance with the certain embodiments. The electrical coil 34 includes a main body portion 42 with a gap 44 extending through the main body portion 42. An exemplary reinforced insulation layer 46 is consolidated around the main body portion 42. The main body portion 42 includes a plurality of terminal ends 48, 50 protruding outwards respectively from a top end 52 and a bottom end 54 respectively of the main body portion 42. The terminal ends 48, 50 include lead portions 56, 58 respectively. In accordance with certain embodiments, uniform consolidation of the insulation layer 46 is achieved around the entire electrical coil 34, including around complex geometries of the terminal ends 48, 50. In other words, uniform consolidation in accordance with the exemplary embodiments refers to the “uniform bonding” of the insulation layer against the electrical coil. The uniform consolidation of the insulation layer 46 around the main body portion 42 of the electrical coil 34 substantially reduces or prevents seepage of water into the electrical coil 34. As a result, deterioration in insulation capacity of the coil 34 is prevented. An exemplary vacuum bag technique used to consolidate the insulation layer 46 in accordance with certain embodiments is discussed in greater detail below.

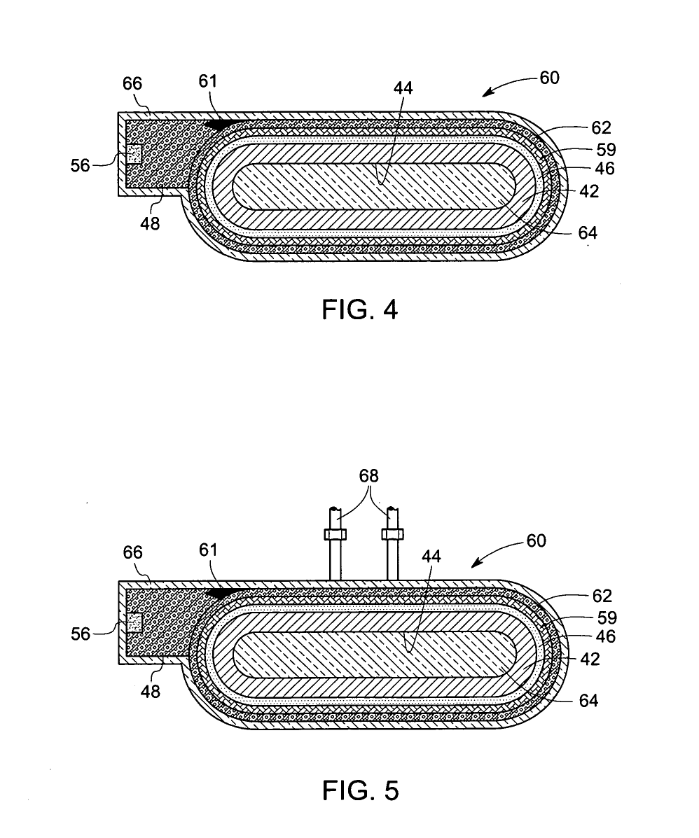

Referring to FIG. 4, a partial sectional view of the electrical coil is illustrated along with an exemplary system 60 used to consolidate the insulation layer 46 around the electrical coil. As discussed above, the electrical coil includes the main body portion 42 and the insulation layer 46 disposed around the main body portion 42. The main body portion 42 includes the plurality of terminal ends protruding outwards respectively from the top end and the bottom end respectively of the main body portion 42. In the illustrated embodiment, only the terminal end 48 of the coil is illustrated. In one example, the insulation layer 46 includes silicone tape. However, other examples of insulation materials are also envisaged. In accordance with certain embodiments, a release layer 59 is wrapped around the insulation layer 46. The release layer 59 may include a heat shrinkable polyester film (example, Mylar manufactured by DuPont). A breather layer (e.g. random spun mat) 62 is wrapped around the release layer 59. One or more silicone wedges 61 may be provided on the breather layer 62 and configured to enhance corona resistance during curing process. The release layer 59 acts as a barrier between the breather layer and 62 and the insulation layer 46 and facilitates easy removal of breather layer 62 after curing process. It should be noted that the insulation layer 46, the release layer 59, and the breather layer 62 are disposed around the main body portion 42 in such a way that the entire main body portion 42 including the terminal ends are covered. In the illustrated embodiment, an inner vacuum bag 64 is disposed in the gap 44 extending through the main body portion 42 of the electrical coil. An outer vacuum bag 66 is disposed around the breather layer 62. In certain embodiments, the vacuum bags 64, 66 may include stretch vac 2000 bagging film, RC-3000-10 stretchable polyester felt breather, manufactured by Richmond Aircraft Products, Norwalk, Calif. 90650. In certain other embodiments, the vacuum bags may include stretchlon SL-850 bagging film, airweave N-10 Breather, or the like, or a combination thereof manufactured by Airtech International, Huntington Beach, Calif. In certain other embodiments, the vacuum bags may include D6600 high temperature polyamide manufactured by De-Comp Composites Inc, Cleveland.

Referring to FIG. 5, a partial sectional view of the electrical coil is illustrated along with an exemplary system 60 used to consolidate the insulation layer 46 around the electrical coil. As discussed previously, the insulation layer 46, the release layer 59, and the breather layer 62 are disposed around the main body portion 42 in such a way that the entire main body portion 42 including the terminal ends are covered. In the illustrated embodiment, the inner vacuum bag 64 is disposed in the gap 44 extending through the main body portion 42 of the electrical coil. The outer vacuum bag 66 is disposed around the breather layer 62. The inner and outer vacuum bags 64, 66 are sealed using one or more sealing tapes or using other suitable sealing techniques. A plurality of vacuum ports 68 are provided to the vacuum bags 64, 66 and are configured to enable a device (e.g., an air pump) to create a “vacuum” in the bags 64, 66. It should be noted that vacuum refers to partial vacuum conditions. For example, one or more vacuum pumps may be used to remove air via the vacuum ports 68 and generate vacuum within the bags 64, 66. The provision of breather layer 62 also facilitates to maintain vacuum within the vacuum bags 64, 66. The vacuum condition within the bags 64, 66 may be monitored using suitable monitoring techniques through the one or more vacuum ports 68.

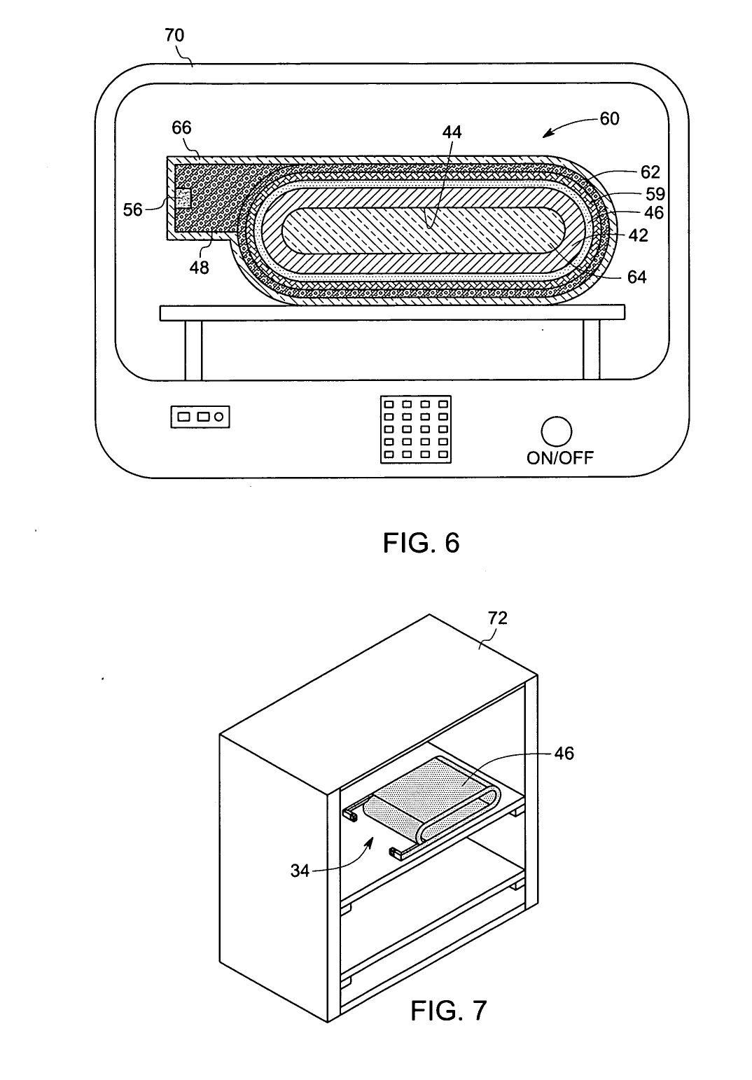

Referring to FIG. 6, a partial sectional view of the electrical coil is illustrated along with an exemplary system 60 used to consolidate the insulation layer 46 around the electrical coil. In the illustrated embodiment, the electrical coil with the system 60 are located inside an autoclave 70 configured to cure the insulation layer 46 under vacuum conditions. Autoclave 70 is a device for heating and pressurizing typically by circulating nitrogen gas. During curing, the coil with the system 60 is subjected to a predetermined pressure and temperature to cure the insulation layer 46. The curing temperature and pressure in the autoclave is determined based on the type of electrical coil, and insulation layer. The vacuum bag material is chosen depending on the curing temperature and pressure. In certain exemplary embodiments, the insulation layer is heated to a temperature of 320 degrees Fahrenheit and subjected to a pressure in the range of 120 psi to 200 psi. The vacuum generated within the vacuum bags 64, 66 allows ambient autoclave pressure to be transmitted to the insulation layer 46 and the coil. Since the coil is completely enclosed within the vacuum bags 64, 66, pressure is uniformly transmitted to the insulation layer 46, thereby facilitating the consolidation of the insulation layer 46 uniformly to the electrical coil. The exemplary process, in accordance with certain embodiments, uses the electrical coil itself as a tool and therefore does not require any mold or additional tooling.

Referring to FIG. 7, a perspective view of an exemplary embodiment of an oven 72 used to cure the electrical coil 34 with the insulation layer 46 is illustrated. As discussed previously, the electrical coil 34 with the insulation is cured to a predetermined pressure and temperature inside the autoclave. After the curing process in the autoclave, the coil 34 is cooled to a lower temperature (e.g. 150 degrees Fahrenheit) and the vacuum bags, breather layer, and the release layer are removed from the electrical coil 34 having the cured insulation layer 46 consolidated around the main body portion of the coil 34. The coil 34 with the insulation layer 46 are located inside the oven 72 to post cure the insulation layer 46 to a second predetermined temperature higher than the predetermined temperature in the autoclave for a predetermined time. In certain exemplary embodiments, the insulation layer 46 is post cured to a temperature of 392 degrees Fahrenheit for about 2 hrs. In certain exemplary embodiments, the curing process in the autoclave and the post curing process in the oven may be combined.

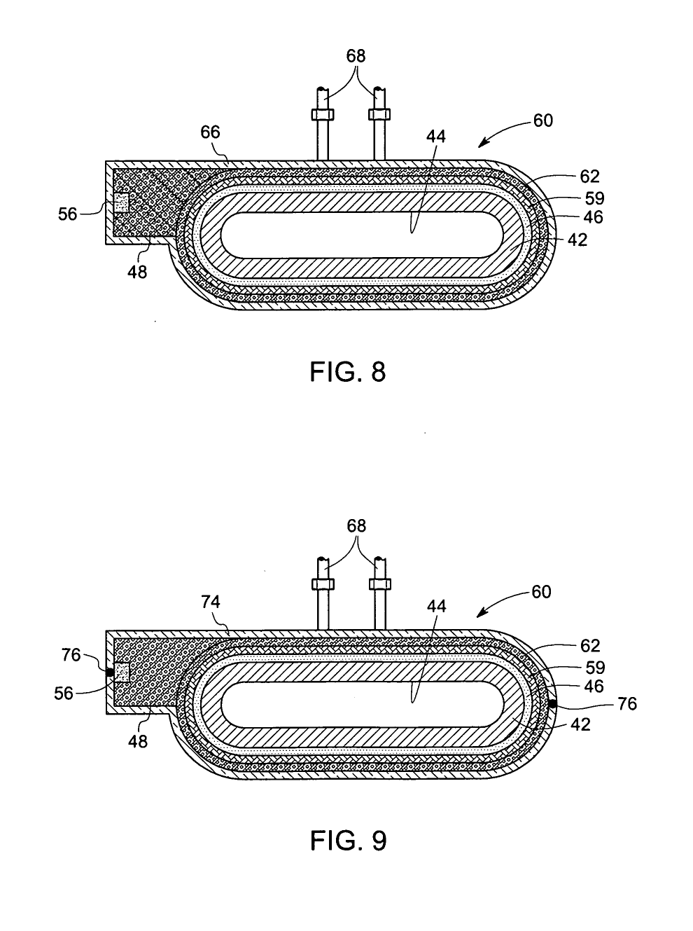

Referring to FIG. 8, a partial sectional view of the electrical coil is illustrated along with the exemplary system 60 used to consolidate the insulation layer 46 around the electrical coil. As discussed previously, the insulation layer 46, the release layer 59, and the breather layer 62 are disposed around the main body portion 42 in such a way that the entire main body portion 42 including the terminal ends are covered. In the illustrated embodiment, only the outer vacuum bag 66 is disposed around the breather layer 62. Edges of the outer vacuum bag 66 are sealed using one or more sealing tapes or using other suitable sealing techniques. The plurality of vacuum ports 68 are coupled to the vacuum bag 66 and are configured to enable a device (e.g., an air pump) to create a vacuum in the bags 66. For example, one or more vacuum pumps may be used to remove air via the vacuum ports and generate vacuum within the bag 66. The vacuum condition within the bag 66 may be monitored using suitable monitoring techniques through one or more vacuum ports.

Referring to FIG. 9, a partial sectional view of the electrical coil is illustrated along with the exemplary system 60 used to consolidate the insulation layer 46 around the electrical coil. As discussed previously, the insulation layer 46, the release layer 59, and the breather layer 62 are disposed around the main body portion 42 in such a way that the entire main body portion 42 including the terminal ends are covered. In the illustrated embodiment, the system 60 includes a tubular vacuum bag 74 disposed around the breather layer 62. Edge of the tubular vacuum bag 74 is sealed using a single continuous seam 76 extending along the bag 74. The plurality of vacuum ports 68 are coupled to the vacuum bag 74 and are configured to enable a device (e.g., an air pump) to create a vacuum in the bags 66. For example, one or more vacuum pumps may be used to remove air via the vacuum ports and generate vacuum within the bag 66.

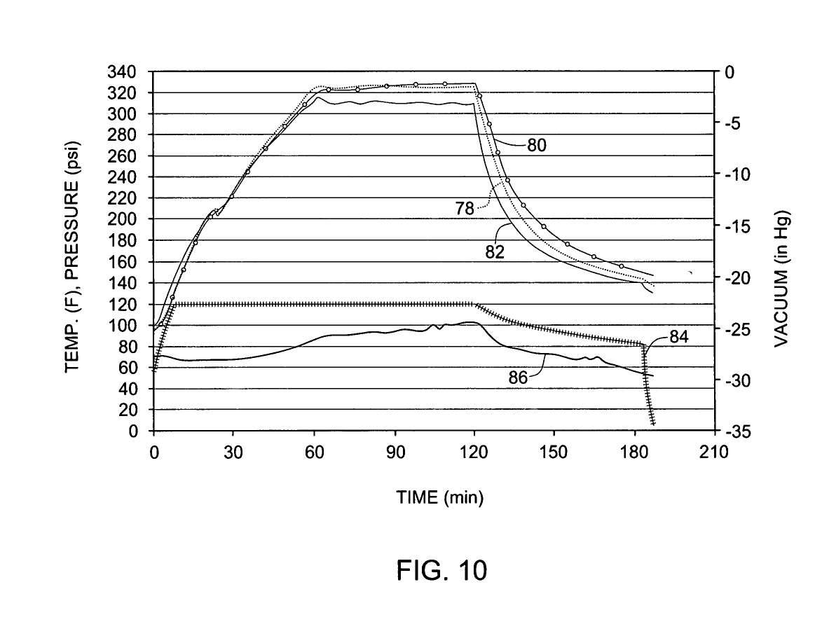

Referring to FIG. 10, a graph representing variation of autoclave temperature (e.g., degrees Fahrenheit), autoclave pressure (e.g., psi), and vacuum pressure (e.g., inches Hg) relative to time (e.g., minutes) is illustrated. Curves 78, 80 represent temperature of the electrical coil at two different locations of the coil detected using temperature sensors during the curing cycle of the coil. Curve 82 represents air temperature in the autoclave during curing cycle. Curve 84 represents air pressure in the autoclave during curing cycle. Curve 86 represents vacuum pressure within the vacuum bag during the curing cycle.

In accordance with the illustrated embodiment and also with reference to FIG. 5, the insulation layer, the release layer, and the breather layer are disposed around the main body portion in such a way that the entire main body portion including the terminal ends are covered. In the illustrated embodiment, the inner vacuum bag is disposed in the gap extending through the main body portion of the electrical coil. The outer vacuum bag is disposed around the breather layer. The plurality of vacuum ports are coupled to the vacuum bags and are configured to enable a device (e.g., an air pump) to create a vacuum in the bags. In the illustrated embodiment, heating rate of the coil in the autoclave is 3 to 4 degrees Fahrenheit per minute. During the curing cycle, initially the autoclave temperature and pressure increases up to a certain point, then becomes uniform and thereafter gradually reduces. It should be noted that the variation of the autoclave temperature, pressure, and the vacuum pressure relative to time illustrated in the graph are merely examples and may vary depending on the type of electrical coil and also on the material of the insulation layer, breather layer, and the vacuum bag.

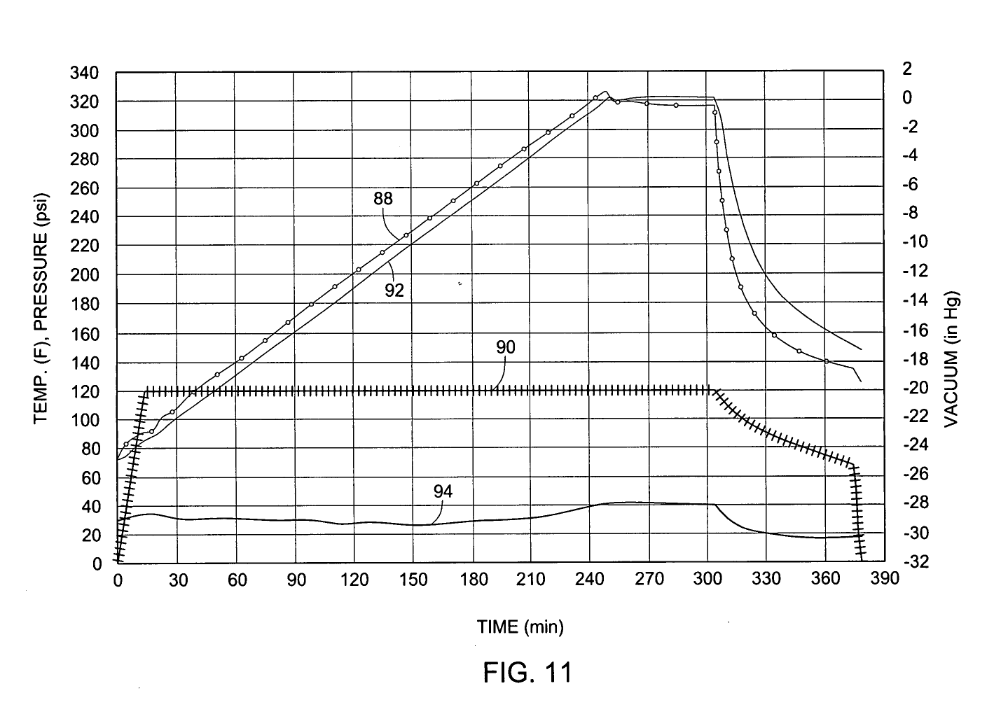

Referring to FIG. 11, a graph representing variation of autoclave temperature (e.g., degrees Fahrenheit), autoclave pressure (e.g., psi), and vacuum pressure (e.g., Hg) relative to time (e.g., minutes) is illustrated. Curve 88 represents air temperature in the autoclave during curing cycle. Curve 90 represents air pressure in the autoclave during curing cycle. Curve 92 represents temperature on the surface of the vacuum bag. Curve 94 represents vacuum pressure within the vacuum bag during the curing cycle.

In accordance with the illustrated and also with reference to FIG. 9, the insulation layer, the release layer, and the breather layer are disposed around the main body portion in such a way that the entire main body portion 42 including the terminal ends are covered. In the illustrated embodiment, the system includes the tubular vacuum bag disposed around the breather layer. Edge of the tubular vacuum bag is sealed using a single continuous seam extending along the bag. The plurality of vacuum ports is coupled to the vacuum bag and is configured to enable a device (e.g., an air pump) to create a vacuum in the bags. In the illustrated embodiment, heating rate of the coil in the autoclave is 1 degree Fahrenheit per minute. During the curing cycle, initially the autoclave temperature and pressure increases up to a certain point, then become uniform and thereafter gradually reduce. In certain exemplary embodiments, the vacuum pressure is maintained uniform (e.g. −30 to −28 Hg). Here again, it should be noted that the variation of the autoclave temperature, pressure, and the vacuum pressure relative to time illustrated in the graph are merely examples and may vary depending on the type of electrical coil and also on the material of the insulation layer, breather layer, and the vacuum bag.

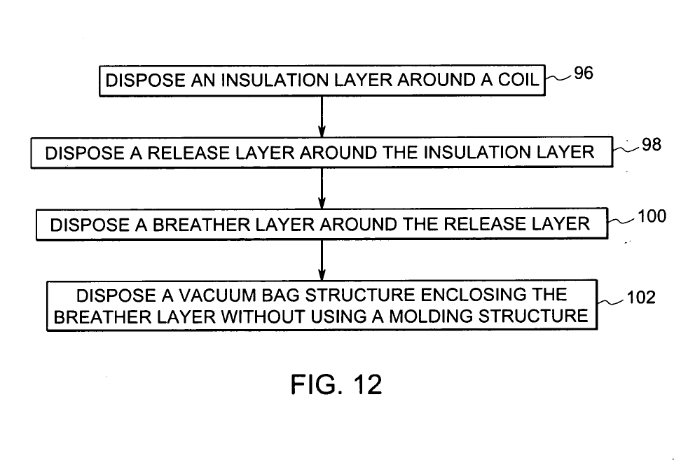

Referring to FIG. 12, a flow chart illustrating exemplary steps involved in the process of curing and consolidating the insulation layer around the electrical coil in accordance with certain embodiments. The process includes disposing the insulation layer around the main body portion of the electrical coil as represented by step 96. In certain embodiments, the insulation layer includes one or more silicone tapes. The main body portion includes the plurality of terminal ends protruding outwards respectively from the top end and the bottom end respectively of the main body portion. The release layer is wrapped around the insulation layer as represented by the step 98. The breather layer is wrapped around the release layer as represented by the step 100. In certain exemplary embodiments, the breather layer includes a random spun mat. The release layer acts as a barrier between the breather layer and the insulation layer and facilitates easy removal of breather layer from the insulation layer after curing and consolidation process of the insulation layer. It should be noted that the insulation layer, the release layer, and the breather layer are disposed around the main body portion in such a way that the entire main body portion including the terminal ends are covered. In the illustrated embodiment, a vacuum bag structure is disposed around the breather layer without using the mold structure as represented by the step 102. In certain exemplary embodiments, the vacuum bag structure includes the inner vacuum bag disposed in the gap extending through the main body portion of the electrical coil and an outer vacuum bag disposed around the breather layer. In certain exemplary embodiments, the vacuum bag structure including only the outer vacuum bag disposed around the breather layer. In certain other exemplary embodiments, the vacuum bag structure includes a tubular bag having a continuous seam may be disposed around the breather layer. The exemplary process, in accordance with certain embodiments, uses the electrical coil itself as a tool and therefore does not require any mold or additional tooling.

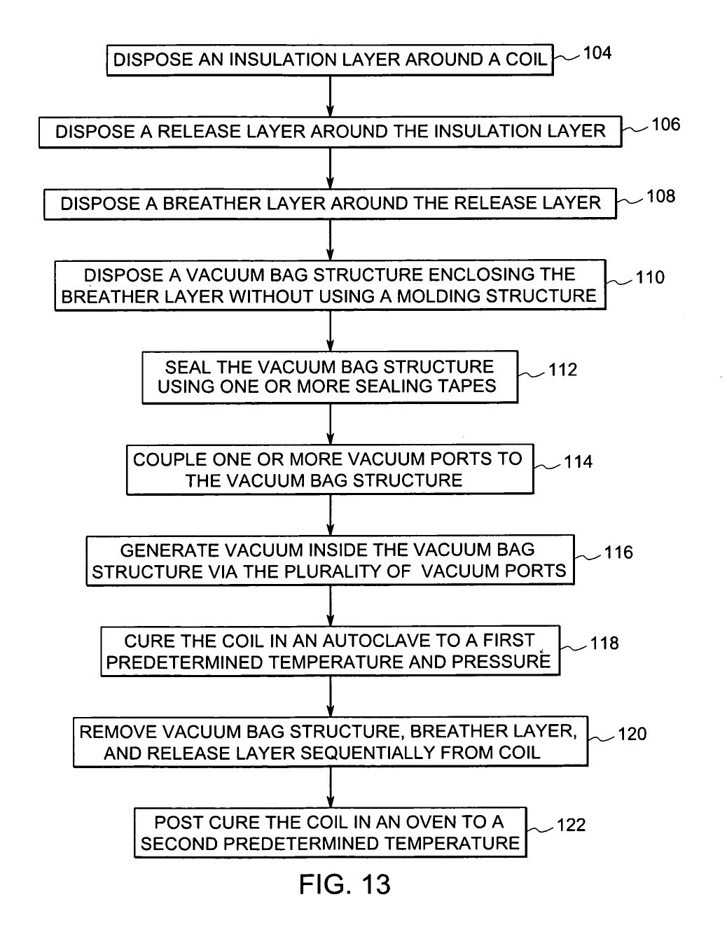

Referring to FIG. 13, a flow chart illustrating exemplary steps involved in the process of curing and consolidating the insulation layer around the electrical coil in accordance with certain embodiments. The process includes disposing the insulation layer around the main body portion of the electrical coil as represented by step 104. The main body portion includes the plurality of terminal ends protruding outwards respectively from the top end and the bottom end respectively of the main body portion. The release layer is wrapped around the insulation layer as represented by the step 106. The breather layer is wrapped around the release layer as represented by the step 108. The release layer acts as a barrier between the breather layer and the insulation layer and facilitates easy removal of breather layer from the insulation layer after curing and consolidation process of the insulation layer. It should be noted that the insulation layer, the release layer, and the breather layer are disposed around the main body portion in such a way that the entire main body portion including the terminal ends are covered. In the illustrated embodiment, a vacuum bag structure is disposed around the breather layer without using the mold structure as represented by the step 110. As discussed previously, the vacuum bag structure may include the inner vacuum bag, and the outer vacuum bag, or only the outer vacuum bag, or the tubular vacuum bag having a continuous seam, or a combination thereof.

The exemplary method further includes coupling one or more vacuum ports to the vacuum bag structure as represented by the step 114. Air is removed via the vacuum ports from within the vacuum bag structure to generate a vacuum within the vacuum bag structure. The vacuum condition may be monitored using any suitable vacuum monitoring techniques. In the illustrated embodiment, the electrical coil with the insulation layer, release layer, breather layer, and the vacuum bag structure are located inside the autoclave configured to cure the insulation layer under vacuum conditions. During curing, the coil with the electrical coil and the insulation layer are subjected to a predetermined pressure and temperature to cure the insulation layer as represented by the step 118. The curing temperature and pressure in the autoclave is determined based on the type of electrical coil, insulation layer. The vacuum bag material is chosen based on the curing temperature and pressure. The vacuum generated within the vacuum bag structure allows ambient autoclave pressure to be transmitted to the insulation layer and the coil. Since the coil is completely enclosed within the vacuum bag structure, pressure is uniformly transmitted to the insulation layer, thereby facilitating to consolidate the insulation layer uniformly to the electrical coil.

After the curing process in the autoclave, the coil is cooled and the vacuum bags, breather layer, and the release layer are removed from the electrical coil having the cured insulation layer consolidated around the main body portion of the coil as represented by the step 120. The coil with the insulation layer are located inside the oven to post cure the insulation layer to a second predetermined temperature higher than the predetermined temperature in the autoclave for a predetermined time as represented by the step 122. In certain exemplary embodiments, the insulation layer is post cured to a temperature of 392 degrees Fahrenheit for about 2 hrs. In certain exemplary embodiments, the curing process in the autoclave and the post curing process in the oven may be combined.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method, comprising:
disposing a vacuum bag structure about an insulation layer along a surface of an electrical coil;
consolidating the insulating layer about the electrical coil via the vacuum bag structure without using a mold structure.

2. The method of claim 1, further comprising disposing an insulation layer around the surface of the electrical coil.

3. The method of claim 2, further comprising disposing a release layer around the insulation layer.

4. The method of claim 3, further comprising disposing a breather layer around the release layer.

5. The method of claim 4, further comprising disposing the vacuum bag structure around the breather layer.

6. The method of claim 5, wherein disposing the vacuum bag structure comprises disposing a single bag around the breather layer.

7. The method of claim 5, wherein disposing the vacuum bag structure comprises disposing a plurality of bags around the breather layer.

8. The method of claim 5, further comprising coupling one or more vacuum ports to the vacuum bag structure.

9. The method of claim 8, further comprising generating vacuum inside the vacuum bag structure via the plurality of vacuum ports.

10. The method of claim 9, further comprising curing the insulation layer in an autoclave to a first predetermined temperature and pressure.

11. The method of claim 10, further comprising removing the vacuum bag structure, breather layer, and the release layer sequentially from the coil.

12. The method of claim 11, further comprising post curing the coil in an oven to a second predetermined temperature.

13. A coil having the insulation layer produced by the method of claim 1.

14. A system, comprising:
an insulation layer disposed around an electrical coil;
a release layer disposed around the insulation layer;
a breather layer disposed around the release layer; and
a vacuum bag structure disposed around the breather layer generally without using a molding structure.

15. The system of claim 14, wherein the insulation layer comprises a silicone tape wrapped around the electrical coil.

16. The system of claim 14, wherein the breather layer comprises a random spun mat wrapped around the release layer.

17. The system of claim 14, wherein the vacuum bag structure comprises a single bag disposed around the breather layer.

18. The system of claim 14, wherein the vacuum bag structure comprises a plurality of bags disposed around the breather layer.

19. The system of claim 14, wherein the vacuum bag structure is sealed.

20. The system of claim 19, further comprising one or more vacuum ports coupled to the vacuum bag structure.

21. The system of claim 14, further comprising one or more silicone wedges provided on top of the breather layer and configured to enhance corona resistance during curing of the coil.

22. An electromechanical device, comprising:
an electrical coil; and
a vacuum-bag-consolidated insulation layer disposed about the electrical coil.

23. The electromechanical device of claim 22, comprising a generator having the electrical coil.

24. The electromechanical device of claim 22, comprising a motor having the electrical coil.

25. The electromechanical device of claim 22, wherein the vacuum-bag-consolidated insulation layer comprises one or more silicone tapes wrapped around the electrical coil.

26. The electromechanical device of claim 22, wherein the electrical coil is used as a tool to consolidate the insulation layer around the electrical coil.

27. A system, comprising:
a vehicle traction mechanism, comprising:
an electrical coil; and
a vacuum-bag-consolidated insulation layer disposed about the electrical coil.

28. The system of claim 27, comprising a vehicle having the vehicle traction mechanism.

29. The system of claim 28, wherein the vehicle comprises a locomotive.

30. The system of claim 27, wherein the vehicle traction mechanism comprises a traction motor having the electrical coil.

31. The system of claim 27, wherein the vacuum-bag-consolidated insulation layer comprises one or more silicone tapes wrapped around the electrical coil.

32. The system of claim 27, wherein the electrical coil is used as a tool to consolidate the insulation layer around the electrical coil.

33. A method, comprising:
creating a vacuum in a vacuum bag structure surrounding an insulation layer along a surface of an electrical coil; and
curing the insulation layer.

34. The method of claim 33, further comprising consolidating the insulation layer about the electrical coil.

35. The method of claim 33, further comprising disposing a release layer around the insulation layer.

36. The method of claim 35, further comprising disposing a breather layer around the release layer.

37. The method of claim 36, further comprising disposing the vacuum bag structure around the breather layer.

38. The method of claim 37, further comprising sealing the vacuum bag structure.
